(19) United States
(12) Patent Application Publication
(10) Pub. No.: US 2014/0289140 A1
(43) Pub. Date: Sep. 25, 2014

(54) SYSTEMS AND METHODS OF OPPORTUNISTICALLY IDENTIFYING NETWORKING PROSPECTS

(71) Applicant: salesforce.com, inc., San Francisco, CA (US)

(72) Inventor: Amit VIJAYANT, San Francisco, CA (US)

(73) Assignee: salesforce.com, inc., San Francisco, CA (US)

(21) Appl. No.: 14/147,318

(22) Filed: Jan. 3, 2014

Related U.S. Application Data
(60) Provisional application No. 61/804,078, filed on Mar. 21, 2013.

(51) Int. Cl. G06Q 50/00; H04W 4/02

(52) U.S. Cl. CPC G06Q 50/01; H04W 4/023
USPC 705/319

(57) ABSTRACT

The technology disclosed relates to automatically suggesting rendezvous with nearby networking prospects. In particular, it relates to opportunistically filling a user's free time with business networking activities by identifying other users that are in geographic proximity to the user and meet the user's business preferences for business networking activities.

### RELATED APPLICATION

This application is related to U.S. non-provisional patent application Ser. No. 13/743,895, entitled, “Systems and Methods for Mapping Relevant Personal Connections,” filed on Jan. 17, 2013 (Attorney Docket No. SALE 1023-2/796US). The related application is hereby incorporated by reference for all purposes.

The application claims the benefit of U.S. provisional Patent Application No. 61/804,078, entitled, “Facilitating Business Meetings Through Location-Aware Events,” filed on Mar. 21, 2013 (Attorney Docket No. SALE 1066-1/1127PROV). The provisional application is hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Location based services and online social networks have revolutionized the way users communicate and share information with each other. The availability of large amounts of geographical and social data has enabled the development of systems and methods that identify user communities based on their geographic locations and social data attributes.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows an example environment of opportunistically identifying networking prospects.

FIG. 2 illustrates one implementation of a message sequence chart of opportunistically identifying networking prospects.

FIG. 3 shows one implementation of a rendezvous schema that can be used to store rendezvous records.

FIG. 4 is one implementation of a user interface for accepting business preferences for business networking activities.

FIG. 5 illustrates one implementation of a user interface for presenting rendezvous suggestions.

FIG. 6 is a flowchart of one implementation of opportunistically filling a user's free time with business networking activities.

FIG. 7 is a block diagram of an example computer system for opportunistically identifying networking prospects.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The technology disclosed relates to opportunistically identifying networking prospects by using computer-implemented systems. The technology disclosed can be implemented in the context of any computer-implemented system including a database system, a multi-tenant environment, or the like. Moreover, this technology can be implemented using two or more separate and distinct computer-implemented systems that cooperate and communicate with one another. This technology can be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

As used herein, a given signal, event or value is “dependent on” a predecessor signal, event or value if the predecessor signal, event or value influenced the given signal, event or value. If there is an intervening processing element, step or time period, the given signal, event or value can still be “dependent on” the predecessor signal, event or value. If the intervening processing element or step combines more than one signal, event or value, the signal output of the processing element or step is considered “dependent on” to each of the signal, event or value inputs. If the given signal, event or value is the same as the predecessor signal, event or value, this is merely a degenerate case in which the given signal, event or value is still considered to be “dependent on” the predecessor signal, event or value. “Responsiveness” of a given signal, event or value upon another signal, event or value is defined similarly.

### Introduction

The technology disclosed can be applied to opportunistically fill in users' free time with networking activities. Some users spend many hours doing recreational activities outside work environment. Others spend a large amount of time travelling for work purposes. While doing all this, users are in the vicinity of many other users who might be of great interest to them for business activities. For instance, if a user is at an airport terminal waiting to catch a flight, the chances are that there are other users in the user's proximity who might belong to the same profession as the user or who might qualify as “target customers” of the user.

Currently, such opportunities are not harnessed, especially in the professional context.

The technology disclosed enables a user to set business preferences that can be used as the basis to identify other nearby users who are of interest to the user or with whom the user would prefer to interact. The nearness of the other users is determined by their geographic proximity to the user, which can be calculated using location-based services such as global positioning system (GPS), global navigation satellite system (GNSS), WiFi, near field communication (NFC), or QR codes, WiFi fingerprints/triangulation, etc. It can also be based on check-ins to wireless devices at known locations. The business preferences specify characteristics or attributes that the user prefers in other nearby users, including industries in which the other nearby users work in, geographic territories within which the other nearby users are professionally active, job functions of the other nearby users, etc. Once the networking prospects are identified, the technology disclosed makes rendezvous suggestions to the user based on the availabilities of the networking prospects and the user.

### Prospect Networking Environment

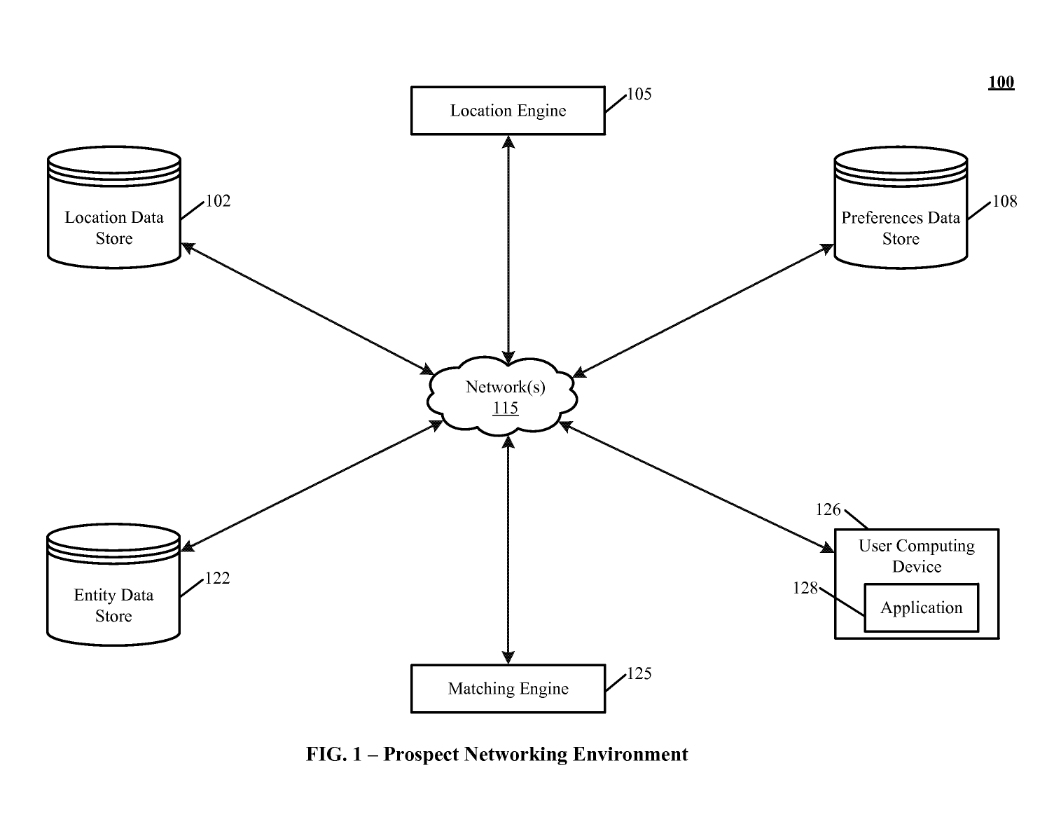

FIG. 1 shows an example environment 100 of opportunistically identifying networking prospects. FIG. 1 includes location data store 102, preferences data store 108, and entity store 122. FIG. 1 also shows location engine 105, matching engine 125, and network(s) 115. In other implementations, environment 100 may not have the same elements or components as those listed above and/or may have other/different elements or components instead of, or in addition to, those listed above, such as reporting engine, calendar engine, identification engine, etc. The different elements or components can be combined into single software modules and multiple software modules can run on the same hardware.

In some implementations, network(s) 115 can be any one or any combination of Local Area Network (LAN), Wide Area Network (WAN), WiFi, WiMAX, telephone network, wireless network, point-to-point network, star network, token ring network, hub network, peer-to-peer connections like Bluetooth, Near Field Communication (NFC), Z-Wave, ZigBee, or other appropriate configuration of data networks, including the Internet.

In some implementations, the engines can be of varying types including workstations, servers, computing clusters, blade servers, server farms, or any other data processing systems or computing devices. The engines can be communicably coupled to the databases via a different network connection. For example, location engine 105 can be coupled via the network 115 (e.g., the Internet) and matching engine 125 can be coupled to a direct network link.

In some implementations, datastores can store information from one or more tenants into tables of a common database image to form a multi-tenant database system (MTS). A database image can include one or more database objects. In other implementations, the databases can be relational database management systems (RDBMSs), object oriented database management systems (OODBMSs), distributed file systems (DFS), no-schema database, or any other data storing systems or computing devices. In some implementations, user computing device 126 can be a personal computer, laptop computer, tablet computer, smartphone, personal digital assistant (PDA), digital image capture devices, and the like.

Application 128 can take one of a number of forms, including user interfaces, dashboard interfaces, engagement consoles, and other interfaces, such as mobile interfaces, tablet interfaces, summary interfaces, or wearable interfaces. In some implementations, it can be hosted on a web-based or cloud-based privacy management application running on a computing device such as a personal computer, laptop computer, mobile device, and/or any other hand-held computing device. It can also be hosted on a non-social local application running in an on-premise environment. In one implementation, application 128 can be accessed from a browser running on a computing device. The browser can be Chrome, Internet Explorer, Firefox, Safari, and the like. In other implementations, application 128 can run as engagement consoles on a computer desktop application.

Entity data store 122 specifies various entities (users and organizations) such as contacts, accounts, opportunities, and/or leads and further provides business information related to the respective entities. Examples of business information can include names, addresses, job titles, number of employees, industry types, SIC code, NAICS code, department, territories, market segments, contact information, employer information, stock rate, organization revenue, etc. In one implementation, entity data store 122 can store web or database profiles of the users and organizations as a system of interlinked hypertext documents that can be accessed via the network 115 (e.g., the Internet). In another implementation, entity data store 122 can also include standard profile information about persons and organizations. This standard profile information can be extracted from company websites, business registration sources such as Jigsaw, Hoovers, or D&B, business intelligence sources such as Yelp, Yellow Pages, and/or social networking websites like Chatter, Facebook, Twitter, LinkedIn, etc.

In other implementations, entity data store 122 can include a contact repository like Salesforce's Data.com, which serves as an electronic business directory of companies and business professionals and holds user generated contact databases. It can also serve as a cloud based data tracking service through which one or more contact databases can be queried. When any relevant records are found, a field-by-field comparison can be performed to determine which information may be imported.

Location data store 102 holds location information related to users. In some implementations, location data store 102 can store at least calendar entries, event subscriptions, sign-ins, and check-ins, or references to the same related to the users. In another implementation, it can provide specific details related to a user's location such as longitude and latitude coordinates of user's real-time geographic location. In one implementation, it can include elevation. In another implementation, users can populate the location data store 102 by specifying their current or future locations on a calendar application or service running on a computing device such as a personal computer, laptop computer, tablet computer, smartphone, etc.

Location engine 105 identifies other users that are in geographic proximity to a particular user by receiving location reference requests from computing devices carried by the users and gathering their location information. These user computing devices include location data transceivers coupled to processors. In some implementations, location engine 105 is repeatedly invoked for different locations to obtain data from location data store 102 that holds location awareness records related to the users, which can be retrieved or constructed dynamically by requesting and combining data from registrations or check-ins.

A user's arrival at a location is automatically detected using, e.g., GNSS, WiFi, Bluetooth, RFID, NFC, or QR codes. In one implementation, location engine 105 can perform location comparisons using GPS information to ascertain that the user is within ten feet of another user. Other threshold distances such as or in a range of 5, 10, 20 or 50 feet can be used. In other implementations, WiFi fingerprints/triangulation, Bluetooth, NFC proximity, RFID or QR scanning codes can be used to immediately detect the arrival of the user at the location.

In one implementation, location engine 105 obtains location information of users when they arrive at a site that is equipped with WiFi, Bluetooth, near field communication (NFC) tags/stickers, or quick response (QR) codes adapted to interact with user computing device 126. In this implementation, a smartphone, equipped with the requisite communications and/or imaging capabilities, can communicate with the on-site equipment and communicate results to a remote server such as the location engine 105. In another implementation, location engine 105 can access specific details related to scheduled locations of users like location of calendar events (address, longitude, latitude, elevation), stored in location store 102.

Once the arrival is detected, a check-in process can be automatically initiated according to one implementation. In this implementation, a check-in request can be automatically generated and presented to the user via his smartphone or other user computing device 106. In another implementation, the check-in request can be fully automatic, providing only a short message on the user computing device 106. In another implementation, the user can be presented with a prompt, to which a response can be requested. In yet another implementation, the check-in can proceed silently without notifying the user. In any of the above or other implementations, the check-in request can be delayed for a period of time or an indicator can be set to show that a check-in request is pending and that a response is awaited.

In one implementation, the check-in can be initiated in response to the user actions such as providing a voice command or selecting an indicator or screen object displayed on an interface. Furthermore, the user can share his check-in information with other users by posting a summary of the check-in on his online social networks such as Chatter, Facebook, Twitter, etc. In some implementations, the check-in summary can include a combination of textual (comments, mentions) and non-textual content (badges, maps shots).

Preferences data store 108 includes business preferences of the users for business networking activities to fill the user's free time. In one implementation, business preferences of the users specify characteristics or attributes that they prefer in other nearby users. Such preferences can be based on user's desire to identify prospects that are most likely to convert into accounts. Examples of such business preferences can include industries in which other nearby users work in, geographic territories within which other nearby users are professionally active, or job functions of other nearby users. In one example, notifying the users of other nearby users who are decision makers at their organizations (based on their job functions) can save the users from pitching to individuals who may not be influential in closing sales deals and can result in shortening of sales cycles for the user.

Business preferences can also specify attributes such as skills and expertise of other nearby users that are of interest to the users for purposes such as recruitment, identifying attendees with backgrounds similar to the users, identifying experts or “gurus” in different industries, etc. For example, a user can specify in his business preferences that he seeks notification of other nearby users who are Java developers with at least five years of experience or who are leaders in their respective industries. In some implementations, business preferences can be assembled from external sources. Examples of external sources can include Data.com, Salesforce.com, ExactTarget Marketing Cloud, Jigsaw, Dun & Bradstreet, LinkedIn.com, Chatter, or Facebook. In some implementations, a crawler can extract business preferences by spidering social media sources in which the users have accounts, profiles, or personas.

Matching engine 125 identifies other nearby users who meet the business preferences specified by a particular user in the preferences data store 108. In some implementations, matching engine 125 can compare alphanumeric characters of the text of the business preferences of the particular user with the same of the business information of other nearby users. In other implementations, it can use phrase detection (chunking), syntactic analysis, word sense disambiguation, and semantic analysis, and other content analysis techniques to identify other nearby users that match the business preferences of the particular user and qualify as networking prospects. In one implementation, matching engine 125 collects business preferences of a group of users and identifies users who share attributes similar to that of the particular user. Based on the business preferences of the identified users, matching engine 125 can predict the corresponding business preferences of the particular user. Examples of similar attributes include similar job functions, industries, business territories, educational backgrounds, etc.

Once identified, matching engine 125 presents the networking prospects across a user interface of a computing device. In some implementations, it can run analytics such as ranking, annotation, clustering, classification, and prioritization over the generated results. In other implementations, it can stratify the networking prospects into industry types, geographic territories, job functions, skills, and expertise, etc. preferred by the particular user, professional circles of the particular user, degrees of separation with the particular user, social proximities to particular user, and most importantly, location proximities to the particular user.

### Prospect Networking Sequence

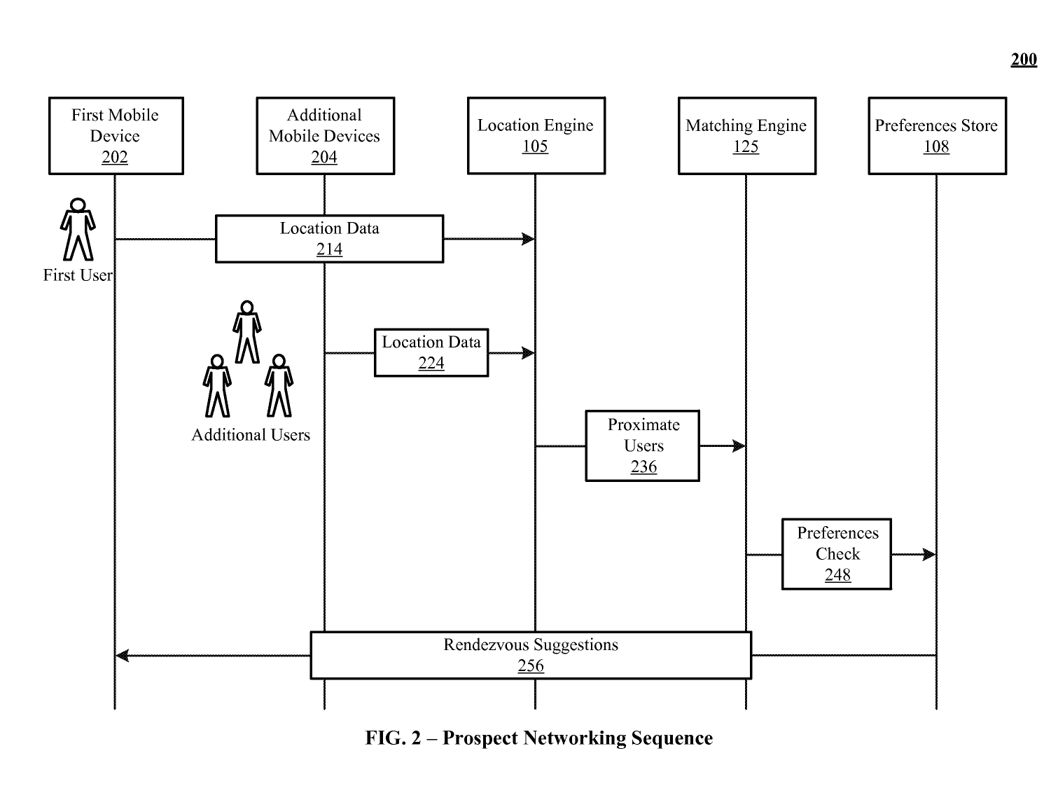

FIG. 2 illustrates one implementation of a message sequence chart 200 of opportunistically identifying networking prospects. Other implementations may perform the exchanges in different orders and/or with different, fewer or additional exchanges than the ones illustrated in FIG. 2. Multiple exchanges can be combined in some implementations. For convenience, this sequence chart is described with reference to the system that carries out a method. The system is not necessarily part of the method.

At exchange 214, location data transceiver of the mobile device 202 carried by the first user sends user's location information such as longitude and latitude coordinates, or elevation to location engine 105. Dependent on this location information, location engine 105 determines the location of the first user. Then at exchange 224, location data transceivers of the mobile devices carried by additional users send users' location information such as longitude and latitude coordinates, or elevation to location engine 105, which uses the location information to determine the locations of the additional users.

After comparing the locations of the first and additional users, location engine 105 identifies those additional users that are in geographic proximity to the first user. In some implementations, a selection of geographic proximity preferences can be received from the first user that sets thresholds of proximities. Once the nearby users are identified, the location engine 105 forwards them to matching engine 125 at exchange 236.

At exchange 248, matching engine 125 invokes preferences data store 108 to filter the identified nearby users dependent on the business preferences of the first user and find networking prospects for the first user. In some implementations, the identified nearby users are filtered dependent on the availability of the first user by comparing the first user's scheduled availability with that of the additional users'. Then at exchange 256, matching engine 125 suggests the networking prospects to the first user for rendezvous.

### Rendezvous Records

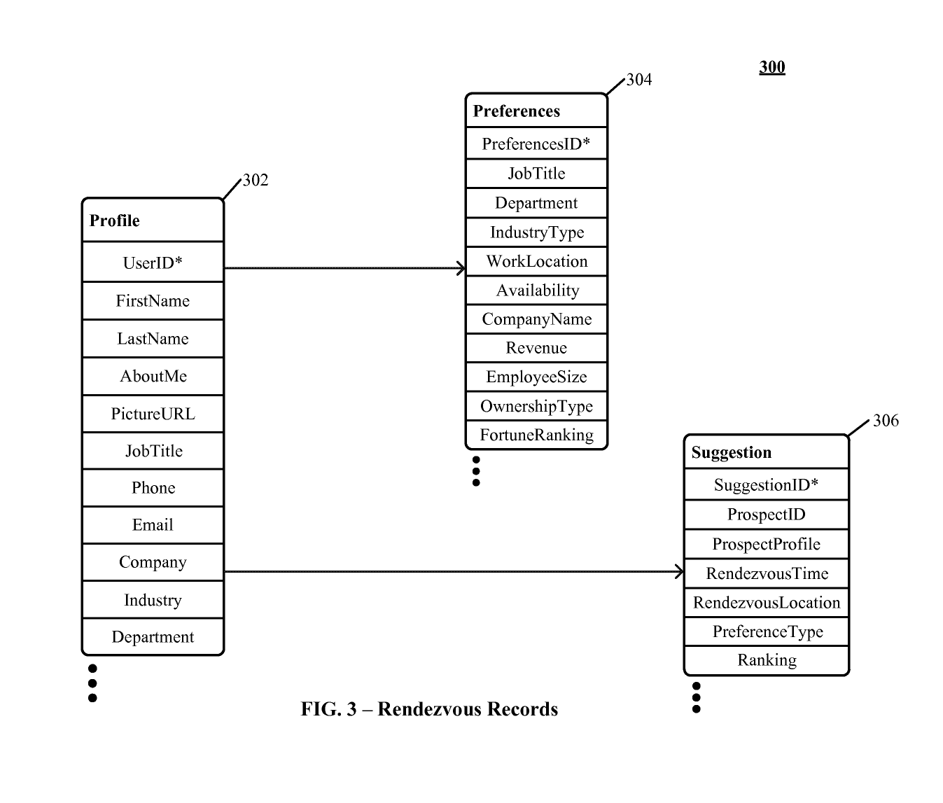

FIG. 3 shows one implementation of a rendezvous schema 300 that can be used to store rendezvous records. This and other data structure descriptions that are expressed in terms of objects can also be implemented as tables that store multiple records or object types. Reference to objects is for convenience of explanation and not as a limitation on the data structure implementation. FIG. 3 shows a profile object 302 linked to a preferences object 304 and suggestion object 306. In other implementations, rendezvous schema 300 may not have the same objects, tables, fields or entries as those listed above and/or may have other/different objects, tables, fields or entries instead of, or in addition to, those listed above such as a statistics object, rules object, or skills object.

As shown in FIG. 3, rendezvous schema 300 is updated to record rendezvous suggestions made to a user. In one implementation, profile object 302 provides primary information that identifies the user and includes various fields that store biographic information about the user such as first name, last name, about me, phone number, department, interests, email, company name, etc. In some implementations, the profile object 302 can be further linked to other objects that provide supplementary information about the user.

In one implementation, profile object 302 is linked to a preferences object 304, which specifies the business preferences of the user for business networking activities to fill the user's free time. In particular, the business preferences specify characteristics or attributes that the user prefers in other nearby users. Examples of the characteristics or attributes include, “JobTitle,” “Department,” “IndustryType,” “WorkLocation,” “Availability,” “CompanyName,” “Revenue,” “EmployeeSize,” etc.

In another implementation, profile object 302 is linked to a suggestion object 306 that records the rendezvous suggestions (RendezvousID) made to the user. Specifically, suggestion object 306 records the suggested networking prospect (ProspectID), business profile of the networking prospect (ProspectProfile), time suggested for the rendezvous (RendezvousTime), location where the rendezvous may have occurred (RendezvousLocation), which attributes of the networking prospect met the business preferences of the user (PreferenceType), and overall ranking of the networking prospect in the rendezvous suggestion based on the availability of the networking prospect or the total number of matched preferences (Ranking)

In yet another implementation, rendezvous schema 300 can have one or more of the following variables with certain attributes: USER_ID being CHAR (15 BYTE), ATTRIBUTE_ID being CHAR (15 BYTE), POSITION_ID being CHAR (15 BYTE), BIO_ID being CHAR (15 BYTE), PROSPECT_ID being CHAR (15 BYTE), LOCATION_ID being CHAR (15 BYTE), CREATED_BY being CHAR (15 BYTE), CREATED_DATE being DATE, and DELETED being CHAR (1 BYTE).

### Business Preferences

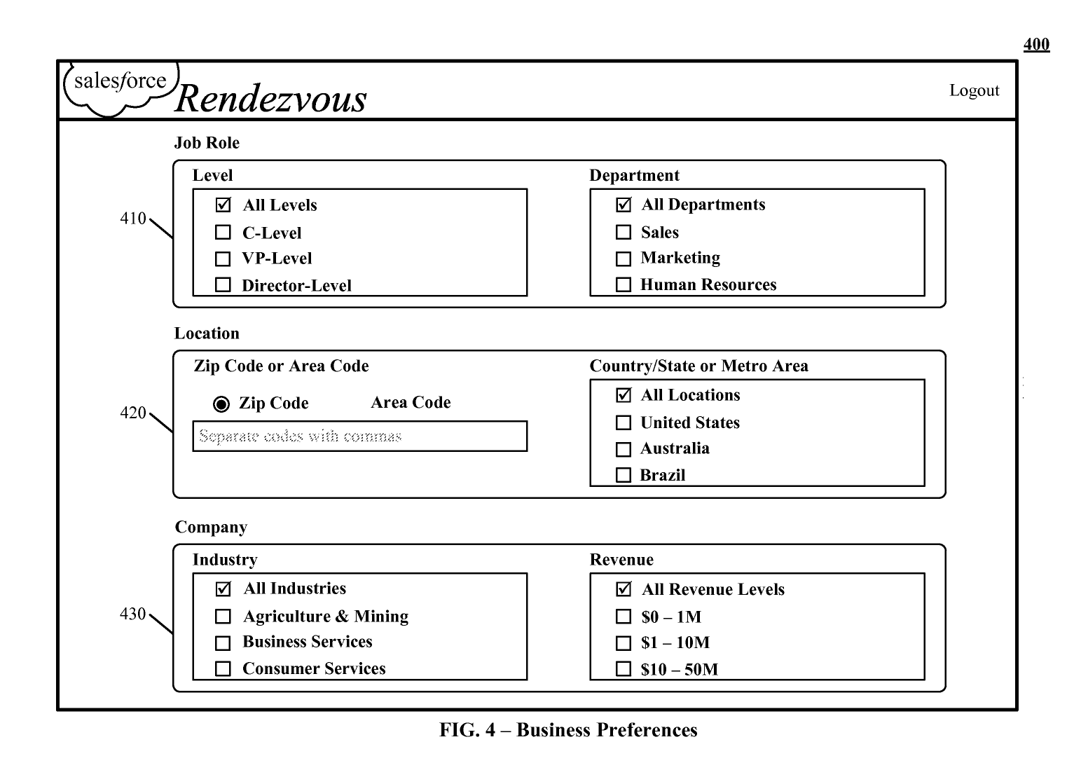

FIG. 4 is one implementation of a user interface 400 for accepting business preferences for business networking activities to fill the user's free time. FIG. 4 includes a job role pane 410, location pane 420, and company pane 430. In other implementations, interface 400 may not have the same screen objects as those listed above and/or may have other/different screen objects instead of, or in addition to, those listed above, including a number of employees pane, fortune ranking pane, ownership pane, etc.

As shown in FIG. 4, users can use interface 400 to specify their business preferences for business networking activities to fill their free time. In particular, users can specify characteristics or attributes that they prefer in other nearby users. For instance, users can use job role pane 410 to specify the job functions of the networking prospects that interest them, such as C-level, VP-level, director-level, manager-level, staff, etc. Similarly, users can use location pane 420 and company pane 430 to respectively set their preferences regarding the work location and companies or employers of the networking prospects.

### Rendezvous Suggestions

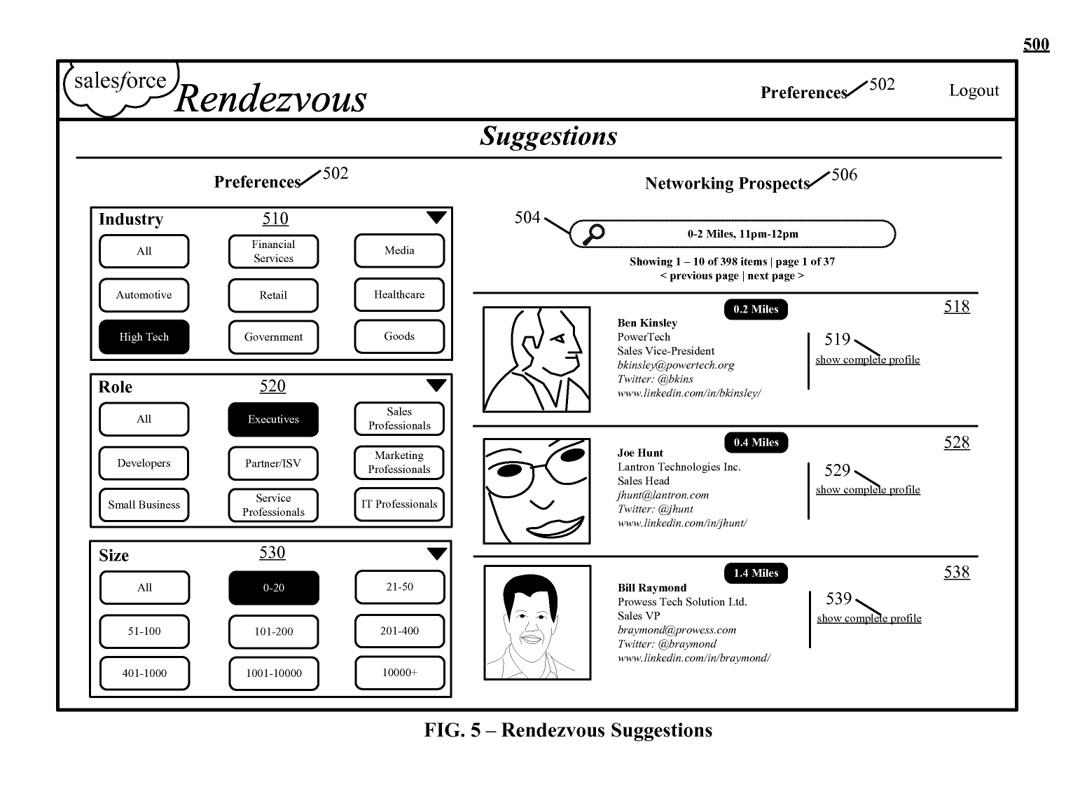

FIG. 5 illustrates one implementation of a user interface 500 for presenting rendezvous suggestions. In particular, FIG. 5 illustrates an example profile of a user on an online social network such as Salesforce's Chatter, which hosts a rendezvous suggestions application. In other implementations, user interface 500 can be presented on different online social networks such as Facebook, Twitter, LinkedIn, etc. FIG. 5 also shows a preferences tab 502, search tab 504, networking prospects tab 506, industry tab 510, role tab 520, employee size tab 530, prospect tabs 518, 528, and 538, and business profile tabs 519, 529 and 539. In other implementations, user interface 500 may not have the same widgets or screen objects as those listed above and/or may have other/different widgets or screen objects instead of, or in addition to, those listed above.

Networking prospects tab 506 displays the networking prospects that meet the business preferences specified by the user in the preferences tab 502. Matched prospects (518, 528 and 538), ‘Ben Kinsley’, ‘Joe Hunt’ and ‘Bill Raymond’, can be identified through their digital business cards, images, contact information, social handles, etc. along with supplemental attendee information accessible through drill down features of business profile tabs 519, 529, and 539. In some implementations, user interface 500 can also include other filters such as availabilities and geographic proximities that identify which networking prospects are available in the same windows of time as the user or which networking prospects are more nearby to the user than others. In one implementation, networking prospects tab 506 highlights the level of proximity of the identified networking prospects in terms of distance. In another implementation, it lists them in a descending order based on the most number of matched business preferences or imminent availability.

### Flowchart of Opportunistically Identifying Networking Prospects

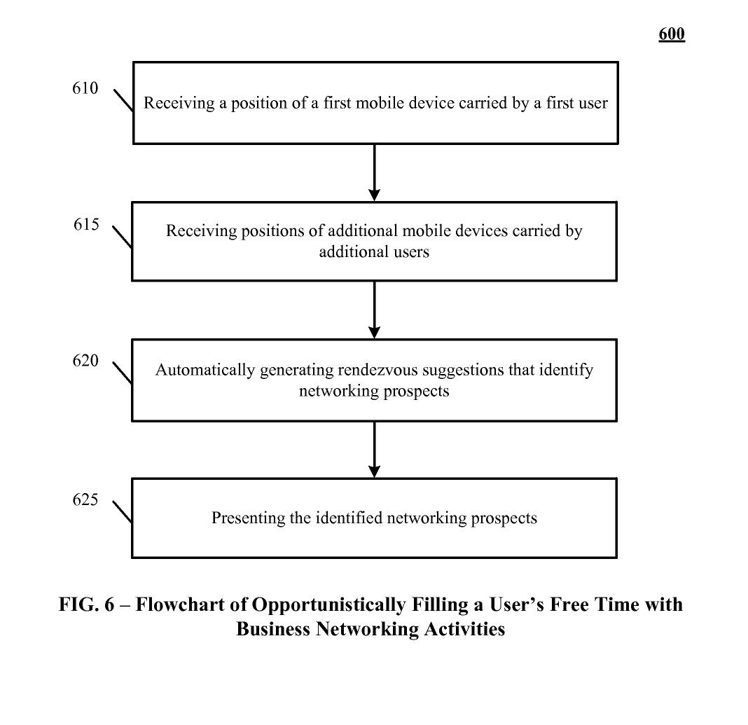

FIG. 6 is a flowchart 600 of one implementation of opportunistically filling a user's free time with business networking activities. Flowchart 600 can be implemented at least partially with a database system, e.g., by one or more processors configured to receive or retrieve information, process the information, store results, and transmit the results. Other implementations may perform the actions in different orders and/or with different, fewer or additional actions than those illustrated in FIG. 6. Multiple actions can be combined in some implementations. For convenience, this flowchart is described with reference to the system that carries out a method. The system is not necessarily part of the method.

At action 610, a first position of a first mobile device carried by a first user is received that provides user's location data including longitude and latitude coordinates, or elevation to location engine 105. Based on this location data, location engine 105 determines the location of the first user. The first user has at least one set of predetermined business preferences for business networking activities to fill his free time. The predetermined business preferences include at least one job function, department, industry type, and work location of the networking prospects. The predetermined business preferences also include at least one availability timeframe of the first user for engaging in the business networking activities. The timeframe is identified by periodically checking a calendar service and determining whether the business networking activities are within a pre-assigned threshold of time that specifies the first user's availability, according to one implementation.

At action 615, additional positions of additional mobile devices carried by additional users are received. Location engine 105 uses this information to determine the locations of the additional users. The additional users have additional predetermined business preferences for business networking activities. The predetermined business preferences include at least one job function, department, industry type, and work location of the networking prospects. The predetermined business preferences also include at least one availability timeframe of the respective additional users for engaging in business networking activities. The timeframe is identified by periodically checking a calendar service and determining whether the business networking activities are within a pre-assigned threshold of time that specifies the additional users' respective availabilities, according to one implementation.

At action 620, rendezvous suggestions for the first user are generated automatically. These rendezvous suggestions identify networking prospects that satisfy the predetermined business preferences of the first user and are in geographical proximity to the first user. The rendezvous suggestions are generated based in part on at least present positions of first and additional mobile devices. The rendezvous suggestions also are generated based in part on scheduled locations of first and additional users. The rendezvous suggestions further include business profiles of the networking prospects.

At action 625, the identified networking prospects are presented to the first across a user interface of a computing device. In some implementations, analytics such as ranking, annotation, clustering, classification, and prioritization are applied to the generated results. In one implementation, the networking prospects are ranked dependent on the number of matching business preferences and level of geographical proximities to the first user. In another implementation, the networking prospects are stratified into industry types, geographic territories, job functions, skills, and expertise, etc. preferred by the first user, professional circles of the first user, degrees of separation with the first user, social proximities to the first user.

### Computer System

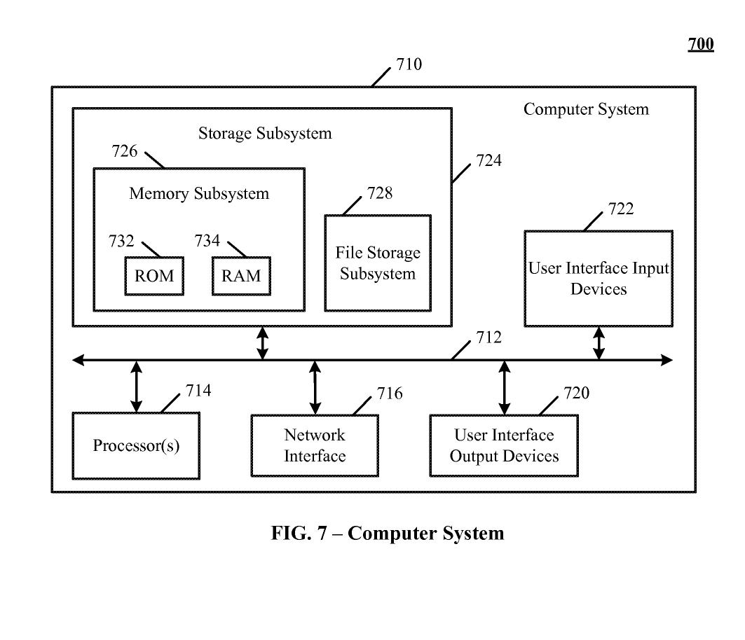

FIG. 7 is a block diagram of an example computer system 700 for opportunistically identifying networking prospects. Computer system 710 typically includes at least one processor 714 that communicates with a number of peripheral devices via bus subsystem 712. These peripheral devices can include a storage subsystem 724 including, for example, memory devices and a file storage subsystem, user interface input devices 722, user interface output devices 720, and a network interface subsystem 716. The input and output devices allow user interaction with computer system 710. Network interface subsystem 716 provides an interface to outside networks, including an interface to corresponding interface devices in other computer systems.

User interface input devices 722 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 710.

User interface output devices 720 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules and methods described herein. These software modules are generally executed by processor 714 alone or in combination with other processors.

Memory 726 used in the storage subsystem can include a number of memories including a main random access memory (RAM) 730 for storage of instructions and data during program execution and a read only memory (ROM) 732 in which fixed instructions are stored. A file storage subsystem 728 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 728 in the storage subsystem 724, or in other machines accessible by the processor.

Bus subsystem 712 provides a mechanism for letting the various components and subsystems of computer system 710 communicate with each other as intended. Although bus subsystem 712 is shown schematically as a single bus, alternative implementations of the bus subsystem can use multiple busses.

Computer system 710 can be of varying types including a workstation, server, computing cluster, blade server, server farm, or any other data processing system or computing device. Due to the ever-changing nature of computers and networks, the description of computer system 710 depicted in FIG. 7 is intended only as one example. Many other configurations of computer system 710 are possible having more or fewer components than the computer system depicted in FIG. 7.

### Particular Implementations

In one implementation, a method is described from the perspective of a server receiving messages from user software. The method includes opportunistically filling a user's free time with business networking activities by receiving a first position of a first mobile device carried by a first user, wherein the first user has at least one set of predetermined business preferences for business networking activities to fill first user's free time. It also includes receiving additional positions of additional mobile devices carried by additional users, wherein the additional users have additional predetermined business preferences for business networking activities. It further includes automatically generating rendezvous suggestions for the first user that identify networking prospects that satisfy the predetermined business preferences of the first user and are in geographical proximity to the first user. The method also includes ranking identified networking prospects dependent on number of matching business preferences and level of geographical proximities.

This method described can be presented from the perspective of a mobile device and user software interacting with a server. From the mobile device perspective, the method includes opportunistically filling a user's free time with business networking activities by receiving a first position of a mobile device carried by a first user, wherein the user has at least one set of predetermined business preferences for business networking activities to fill first user's free time. It also includes receiving additional positions of additional mobile devices carried by additional users, wherein the additional users have additional predetermined business preferences for business networking activities. It further relies on the server to automatically generate rendezvous suggestions for the first user that identify networking prospects that satisfy the predetermined business preferences of the first user and are in geographical proximity to the first user. The method also includes ranking identified networking prospects dependent on number of matching business preferences and level of geographical proximities.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as prospect networking environment, prospect networking sequence, rendezvous records, business preferences, etc.

The rendezvous suggestions take are generated based in part on the predetermined business preferences of the additional users. The rendezvous suggestions also are generated based in part on present positions of first and additional mobile devices. The rendezvous suggestions further are generated based in part on scheduled locations of first and additional users. The rendezvous suggestions further include business profiles of the networking prospects.

The predetermined business preferences can include at least one job function, department, industry type, and work location of the networking prospects. The predetermined business preferences also include at least one availability timeframe for engaging in the business networking activities.

Other implementations can include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

1. A method, including:
receiving a first position of a first mobile device carried by a first user, wherein the first user has at least one set of predetermined business preferences for business networking activities to fill first user's free time;
receiving additional positions of additional mobile devices carried by additional users, wherein the additional users have additional predetermined business preferences for business networking activities; and
automatically generating rendezvous suggestions for the first user that identify networking prospects among the additional users that satisfy the predetermined business preferences of the first user and are in geographical proximity to the first user.

2. The method of claim 1, wherein the rendezvous suggestions are generated based in part on the predetermined business preferences of the additional users.

3. The method of claim 1, wherein the rendezvous suggestions are generated based in part on at least:
present positions of first and additional mobile devices; and
scheduled locations of first and additional users.

4. The method of claim 1, wherein the predetermined business preferences include at least one job function of the networking prospects.

5. The method of claim 1, wherein the predetermined business preferences include at least one department of the networking prospects.

6. The method of claim 1, wherein the predetermined business preferences include at least one industry type of the networking prospects.

7. The method of claim 1, wherein the predetermined business preferences include at least one work location of the networking prospects.

8. The method of claim 1, wherein the predetermined business preferences include at least one availability timeframe for engaging in the business networking activities.

9. The method of claim 1, wherein the rendezvous suggestions include business profiles of the networking prospects.

10. The method of claim 1, further including ranking identified networking prospects dependent on number of matching business preferences and level of geographical proximities.

11. A computer system, including:
a processor and a computer readable storage medium storing computer instructions configured to cause the processor to:
receive a first position of a first mobile device carried by a first user, wherein the first user has at least one set of predetermined business preferences for business networking activities to fill first user's free time;
receive additional positions of additional mobile devices carried by additional users, wherein the additional users have additional predetermined business preferences for business networking activities; and
automatically generating rendezvous suggestions for the first user that identify networking prospects among the additional users that satisfy the predetermined business preferences of the first user and are in geographical proximity to the first user.

12. The system of claim 11, wherein the rendezvous suggestions are generated based in part on the predetermined business preferences of the additional users.

13. The system of claim 11, wherein the rendezvous suggestions are generated based in part on at least:
present positions of first and additional mobile devices; and
scheduled locations of first and additional users.

14. The system of claim 11, wherein the predetermined business preferences include at least one job function of the networking prospects.

15. The system of claim 11, wherein the predetermined business preferences include at least one department of the networking prospects.

16. The system of claim 11, wherein the predetermined business preferences include at least one industry type of the networking prospects.

17. The system of claim 11, wherein the predetermined business preferences include at least one work location of the networking prospects.

18. The system of claim 11, wherein the predetermined business preferences include at least one availability timeframe for engaging in the business networking activities.

19. The system of claim 11, wherein the predetermined business preferences include at least one work location of the networking prospects.

20. The system of claim 11, further including ranking identified networking prospects dependent on number of matching business preferences and level of geographical proximities.
